(19) United States
(12) Patent Application Publication
(10) Pub. No.: US 2026/0249939 A1
(43) Pub. Date: Aug. 27, 2026

(54) ANTI-THEFT DEVICE FOR TWO-WHEEL VEHICLES

(71) Applicant: Charles R. Hammerslough, Chicago, IL (US)

(72) Inventor: Charles R. Hammerslough, Chicago, IL (US)

(73) Assignee: Resilient Accessories LLC, Jacksonville, FL (US)

(21) Appl. No.: 19/545,788

(22) Filed: Feb. 20, 2026

Related U.S. Application Data
(60) Provisional application No. 63/761,296, filed on Feb. 21, 2025.

(51) Int. Cl. B62H 5/14; B60R 25/10; B60R 25/32; B62H 5/20

(52) U.S. Cl. CPC B62H 5/144; B60R 25/1003; B60R 25/32; B62H 5/20

(57) ABSTRACT

An anti-theft system secures a wheel of a two-wheel vehicle using a housing and cooperating curved clamping arms that at least partially enclose the wheel to limit rotation. A fixed curved clamping arm extends from the housing through a wheel aperture, and a movable curved clamping arm slides between a retracted position within the housing and a deployed position toward a free end of the fixed arm. A locking mechanism including a saw-toothed perimeter on the movable arm and a spring-loaded locking lever with a cam-actuated unlock state prevents retraction in a locked state and permits free movement in an unlocked state. A motion-detection-and-alarm subsystem within the housing senses movement and/or vibration and drives a sound transducer to emit a loud audible alarm, which may escalate from a brief warning tone to a sustained alarm tone in response to continued tampering.

### TECHNICAL FIELD

The invention is an anti-theft system that resists roll-away theft of two-wheel vehicles of all types.

### BACKGROUND OF INVENTION

In the United States, theft of motorized vehicles has seen a significant increase in recent years. In 2023, there were 322 cases of vehicles reported stolen at the University of Southern California alone, compared to 67 cases in 2021, representing a 481% increase. This trend is not isolated to a single campus, as electric vehicle thefts have been rising across Los Angeles. From January 1 to Aug. 14, 2023, there were 441 crimes involving motorized vehicles (including e-vehicles) in Los Angeles, a 16% increase from the previous year.

Chains and locks have been quickly cut when used to secure a vehicle to a ground-mounted post. Even where wheel-based locking devices have been used, such vehicles have often simply been lifted into the back of a pick-up and driven away with lock still in place.

Thieves tend to fall into two categories: casual and professional. Casual thieves tend to be opportunistic and the theft is often unplanned. Professional thieves have tools for cutting through locks, clamps, chains and the like.

An effective theft deterrent is one that thwarts both categories of thieves.

### BRIEF DESCRIPTION OF THE INVENTION

The invention herein disclosed is meant to deter both categories of thieves. Its distinctive appearance and color warn casual thieves away. And, its structures and functions make use of tools both detectable and responded to with escalating alarm warnings.

The invention is a system that prevents wheel rotation when deployed, and initiates a loud (110 dB) alarm when it detects movement of the system or vibration from tools applied to it.

The invention comprises a fixed, curved clamping arm; a saw-toothed, curved, movable clamping arm; a locking-and-unlocking subsystem; a motion-detection subsystem; and a transducer that can emit sounds at 110 dB sound level. This is equivalent to the sound level of a power saw or jack hammer.

With the movable clamping arm retracted into its housing, the fixed clamping arm is placed such that the housing is perpendicular to the wheel plane and abuts the tire surface and the fixed clamping arm extends through an opening in the wheel.

The movable clamping arm is then extended such that its end meets or comes close to the end of the fixed clamping arm. Then, the movable arm is locked in place by the lock-and-unlock structure. When so positioned, the system prevents wheel rotation.

The lock-and-unlock mechanism may also activate an internal to the housing motion-detection subsystem which, upon detecting movement of the housing, will emit a 110 dB sound level alarm. The motion-detection subsystem may alternatively be controlled via a mobile-device application or other mobile device.

Locking and unlocking of the movable clamping arm is done by having a saw-toothed surface that is ratcheted against a rotatable, spring-loaded locking lever. When the locking-and-unlocking structure is unlocked, it holds the locking lever away from the saw-tooth surface. When locked, it permits the locking lever to engage with the saw-toothed surface and prevent it from retracting.

Once deployed, the distinctive look may warn away casual thieves, and a piercing tone is emitted when the locked vehicle is moved even slightly or a tool is applied to the locking system. In the event that the first piercing warning is ignored, continued application of a tool, sensed by its vibrations, will evoke a sustain, piercing alarm sound.

### BRIEF DESCRIPTION OF DRAWINGS

Figure1 depicts a top-down view of an embodiment of the invention.

FIG. 2 is a 3D perspective view from above of the FIG. 1 embodiment.

FIG. 3a shows the movable clamping arm partially retracted.

FIG. 3b shows the movable clamping arm fully retracted.

FIG. 4a depicts internal structures in locked orientation.

FIG. 4b depicts internal structures in unlocked orientation.

FIG. 5 illustrates initiating the wheel clamping procedure.

FIG. 6 illustrates completing the wheel clamping procedure.

FIG. 7 shows a block diagram of the relationships between the subsystems.

### DETAILED DESCRIPTION OF INVENTION

The growing popularity of two-wheel vehicles, of all kinds, has spawned a growing number of vehicle thefts. In some cases, an unsecured vehicle is simply rolled away. Where the vehicle is tethered and locked to a stanchion, thieves can quickly cut chain or lock then roll it away. Where a wheel is outfitted with a wheel-rotation-limiting device, some thieves will simply lift up the vehicle and put in the bed of a pick-up truck and drive off. In a first case, a casual thief is warned off by the distinctive look and color of the system. In a second case, where a determined thief has brought tools to use for removing the system, an escalating alarm is emitted upon detection of movement or vibration. If ignored, a continuous piercing alarm is employed.

The invention herein disclosed is a system that provides both wheel-rotation-limiting protection as well as motion-detection-and-alarm capabilities. Motion detection is detected for both movement of the protected vehicle and/or for vibration of a tool being used to eliminate the system. The device, in position, prevents roll-away theft, and the internal motion-detection-and-alarm subsystem helps thwart picking up the vehicle and putting in the back of a truck, or using tools meant to quickly cut through a chain, lock or clamp.

As shown in FIG. 1, the invention (100) makes use of curved clamping arms to attach it to a wheel and prevent roll-away theft. Attached to the arms is an enclosed area that comprises a locking-and-unlocking structure, and a motion-detection-and-alarm subsystem.

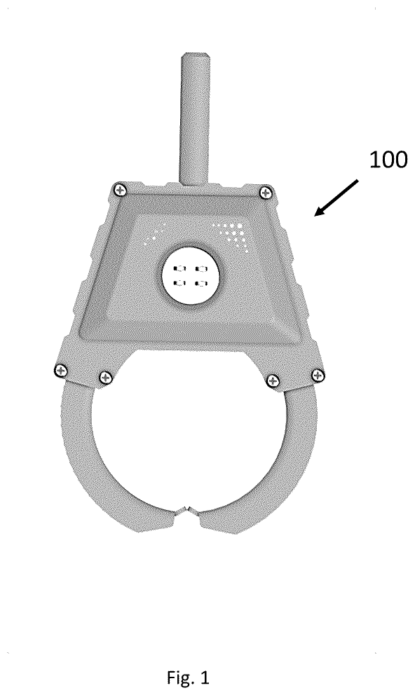

FIG. 2 shows an elevated end-view of the FIG. 1, 100, system. The enclosure portion (201) comprises a locking-and-unlocking structure (202), alarm sound-port openings (203), a movable, lockable, curved clamping arm (204) and a fixed, curved clamping arm (205).

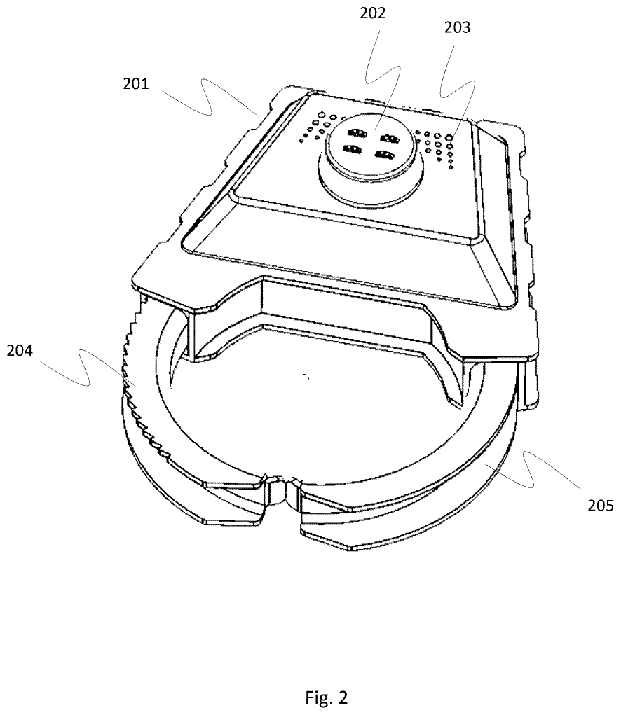

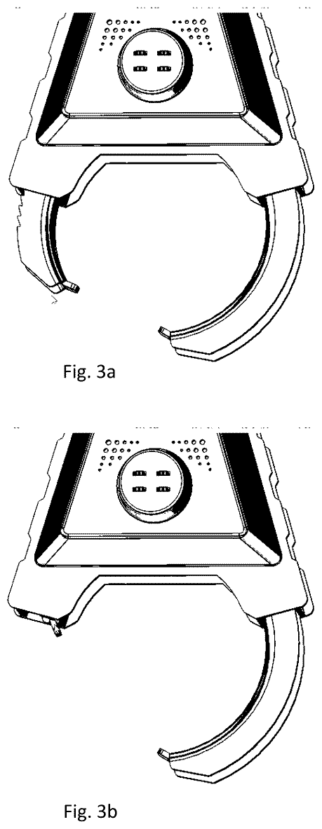

In FIG. 3a the movable, lockable clamping arm is partially retracted, and in FIG. 3b, the movable, lockable clamping arm is fully retracted inside the enclosure housing.

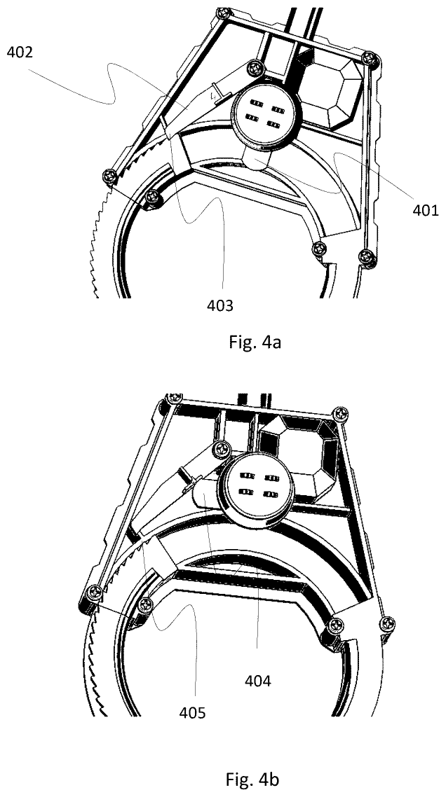

The locking-and-unlocking function comprises, as shown in FIG. 4a shows a rotatable cam (401) and spring-loaded, rotatable locking structure (402). Here, the rotatable cam is not pressing against the locking structure, and the spring presses it against the saw-tooth perimeter of the movable, lockable clamping arm. This creates a ratcheting effect when the arm is extended and a locking effect when retraction is attempted. This is, therefore, the locked orientation.

In FIG. 4b, the cam is now rotated 90 degrees and is pushing on the side of a raised portion of the locking structure (404). As such, the locking structure is moved away from the saw-tooth perimeter allowing the movable, lockable clamping arm to be extended or retracted freely. This is, therefore, the unlocked orientation.

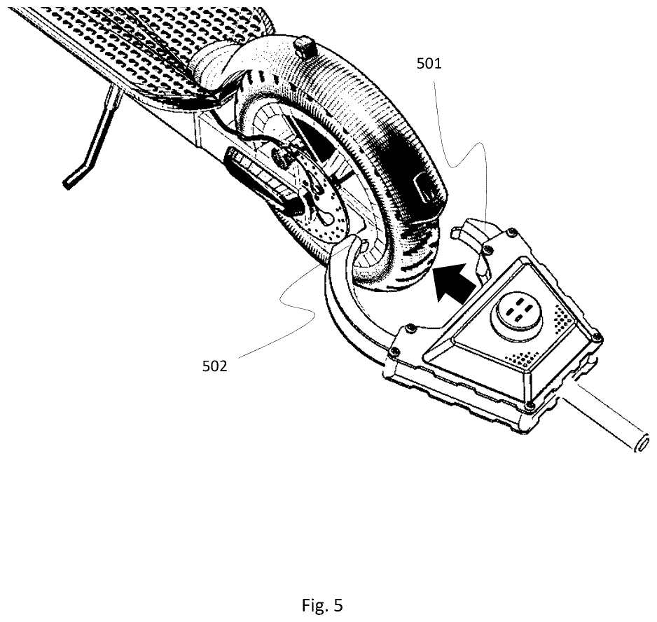

The system is deployed by extracting the movable clamping arm (501), placing the fixed clamping arm through a wheel aperture (502), and then pressing the housing against the tire surface, as depicted in FIG. 5.

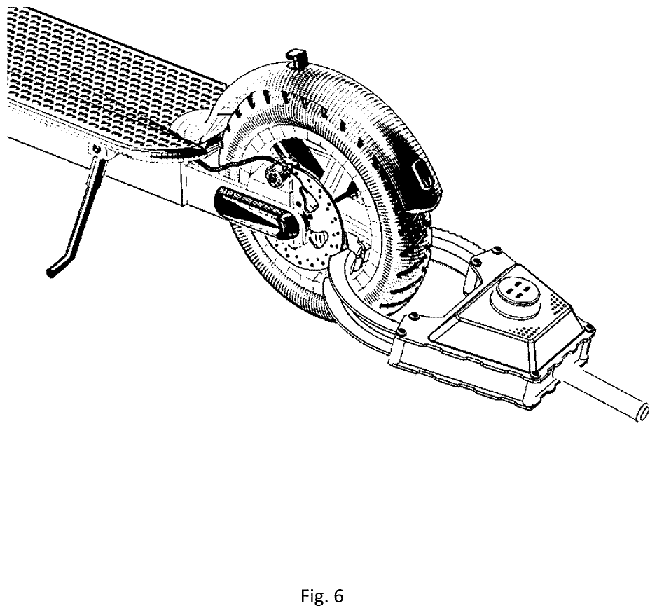

In FIG. 6, the movable, lockable arm has been extended, enfolding the wheel, and then locked into position. This can prevent wheel rotation and roll-away theft.

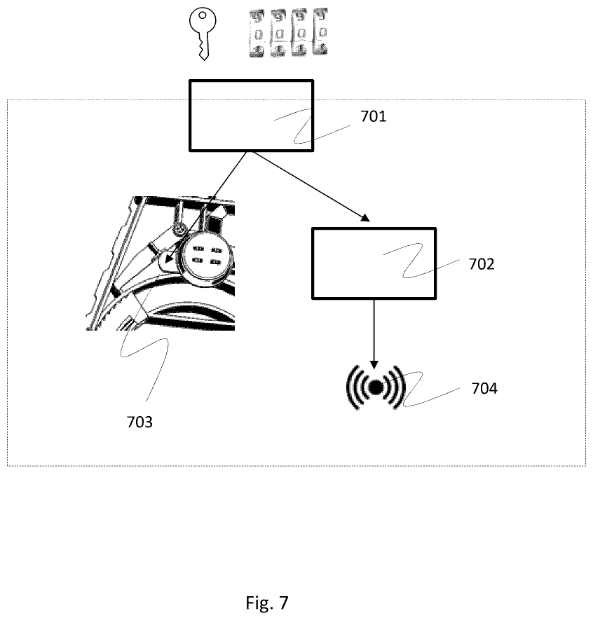

In FIG. 7, the dotted lines show the structures and subsystems within the enclosure housing. A portion of the locking-and-unlocking structure (701) is outside the housing, providing a user key or combination-wheel interface; and a portion inside the housing that can lock or unlock the locking structure (703) as described, and can activate the motion—detection-and-alarm subsystem (702) which when detecting motion or vibration conveys an electrical signal to the sound transducer (704) creating a loud alarm sound which can escalate from a single warning tone to a sustained, piercing alarm sound.

Alternatively, the locking-and-unlocking structure may control on the locking and unlocking of the movable, lockable clamping arm whereas the motion-detection-and-alarm subsystem may be controlled by a separate mobile device.

These figures and descriptions are exemplary. The embodiments described should not be read as limiting the invention to those specific details.

The clamping arms and enclosure housing may be made of a variety of materials such as metals, composites, or rigid polyvinylchloride formulations.

The locking-and-unlocking structure may be key locked or unlocked, or may use knurled combination knob structures.

What is claimed is:

1. An anti-theft system for a two-wheel vehicle having a wheel with a tire and apertures through the wheel, the system comprising:
a housing configured to be positioned adjacent to a surface of the tire with the housing generally perpendicular to a plane of the wheel;
a fixed, curved clamping arm rigidly coupled to the housing and configured, when the housing is positioned adjacent the tire surface, to extend through one of the apertures of the wheel;
a movable, curved clamping arm slidably received in the housing and movable between a retracted position in which the movable clamping arm is contained within the housing and a deployed position in which the movable clamping arm extends from the housing toward a free end of the fixed, curved clamping arm to at least partially enclose the wheel between the fixed and movable clamping arms and thereby limit rotation of the wheel;
a locking-and-unlocking structure disposed in the housing and configured, in a locked state, to prevent retraction of the movable, curved clamping arm from the deployed position and, in an unlocked state, to permit free extension and retraction of the movable, curved clamping arm; and
a motion-detection-and-alarm subsystem disposed in the housing and configured, when activated, to detect at least one of movement of the housing and vibration applied to the system and, in response, to drive a sound transducer to emit an audible alarm.

2. The anti-theft system of claim 1, wherein the movable, curved clamping arm has a saw-toothed perimeter, and the locking-and-unlocking structure comprises a spring-loaded, rotatable locking lever arranged to ratchet over the saw-toothed perimeter during extension of the movable, curved clamping arm and to engage the saw-toothed perimeter to prevent retraction when the locking-and-unlocking structure is in the locked state.

3. The anti-theft system of claim 2, wherein the locking-and-unlocking structure further comprises a rotatable cam configured, in the unlocked state, to press on the spring-loaded, rotatable locking lever and hold the locking lever away from the saw-toothed perimeter to permit free extension and retraction of the movable, curved clamping arm.

4. The anti-theft system of claim 1, wherein the motion-detection-and-alarm subsystem is configured to emit a first, brief warning tone in response to an initial detection of movement or vibration and, in response to continued movement or vibration, to emit a sustained alarm tone.

5. The anti-theft system of claim 1, wherein the sound transducer is configured to emit the audible alarm through sound-port openings formed in the housing.

6. The anti-theft system of claim 1, wherein at least the housing and the clamping arms are formed from a material selected from metals, composite materials, and rigid polyvinylchloride formulations.

7. The anti-theft system of claim 1, wherein the locking-and-unlocking structure includes a user interface disposed on an exterior of the housing selected from a key-operated lock, a knurled combination knob, and an electronically activated lock.

8. The anti-theft system of claim 1, wherein the motion-detection-and-alarm subsystem comprises an electronic motion sensor configured to sense at least one of translation and rotation of the housing.

9. The anti-theft system of claim 1, wherein the motion-detection-and-alarm subsystem is further configured to sense vibration associated with a cutting tool applied to the system.

10. The anti-theft system of claim 1, wherein the fixed, curved clamping arm and the movable, curved clamping arm have complementary radii of curvature selected to conform to an outer diameter of the wheel.

11. The anti-theft system of claim 1, wherein, for deployment, the movable, curved clamping arm is unlocked and retracted into the housing, the fixed, curved clamping arm is inserted through the aperture of the wheel, and the housing is pressed against the tire surface so that, when the movable, curved clamping arm is extended and locked, the wheel is at least partially enclosed between the fixed and movable clamping arms.

12. The anti-theft system of claim 1, wherein the motion-detection-and-alarm subsystem is automatically activated when the locking-and-unlocking structure is placed in the locked state.

13. The anti-theft system of claim 1, wherein the motion-detection-and-alarm subsystem is configured to be activated and deactivated via a mobile device or a mobile-device application independently of the locking-and-unlocking structure.

14. The anti-theft system of claim 1, wherein the anti-theft system has a distinctive exterior appearance including a predetermined color scheme configured to visually deter casual thieves.

15. The anti-theft system of claim 1, wherein the vehicle is selected from a bicycle, an electric bicycle, a scooter, and any two-or three-wheel vehicle.

16. A method of deterring theft of a two-wheel vehicle having a wheel with a tire and apertures through the wheel, the method comprising:
placing a housing of an anti-theft system adjacent a surface of the tire with a fixed, curved clamping arm coupled to the housing extending through one of the apertures of the wheel;
extending a movable, curved clamping arm from the housing toward a free end of the fixed, curved clamping arm so that the wheel is at least partially enclosed between the fixed and movable curved clamping arms and rotation of the wheel is limited;
locking the movable, curved clamping arm in the extended position using a locking-and-unlocking structure in the housing; and
activating a motion-detection-and-alarm subsystem in the housing to detect at least one of movement of the housing and vibration applied to the anti-theft system and, in response, to emit an audible alarm of at least 110 dB.
